(19) United States
(12) Patent Application Publication
(10) Pub. No.: US 2026/0326369 A1
(43) Pub. Date: Oct. 22, 2026

(54) REPAIRING A THREE-DIMENSIONAL PRINTED OBJECT USING A SECONDARY POWDER FUSION BED

(71) Applicant: International Business Machines Corporation, Armonk, NY (US)

(72) Inventors: Tushar AGRAWAL, West Fargo, ND (US); Carolina GARCIA DELGADO, Zapopan (MX); Sarbajit Kumar RAKSHIT, Kolkata (IN); Neil DELIMA, Scarborough (CA)

(21) Appl. No.: 19/180,933

(22) Filed: Apr. 16, 2025

(51) Int. Cl. B29C 64/188; B29C 64/153; B29C 64/393; B33Y 10/00; B33Y 40/20; B33Y 50/02

(52) U.S. Cl. CPC B29C 64/188; B29C 64/153; B29C 64/393; B33Y 10/00; B33Y 40/20; B33Y 50/02

(57) ABSTRACT

A three-dimensional (3D) printing system may receive a 3D printed object. The 3D printing system may identify a defective portion of the 3D printed object to be repaired. The 3D printing system may evaluate, by moving the 3D printed object using one or more robotic arms, an accessibility of the defective portion. The 3D printing system may determine, based on the accessibility of the defective portion, an orientation of the 3D printed object for repairing the defective portion. The 3D printing system may deposit material to create a localized secondary powder bed on the defective portion while the one or more robotic arms maintain the 3D printed object in the orientation. The 3D printing system may fuse the material of the localized secondary powder bed to the defective portion to repair the defective portion.

### BACKGROUND

This disclosure relates to three-dimensional (3D) printing, and more specifically, to repairing a 3D printed object using a secondary powder fusion bed.

### SUMMARY

Some aspects described herein relate to a method. The method may include receiving a 3D printed object in a 3D printing system, where the 3D printing system includes one or more robotic arms. The method may include identifying a defective portion of the 3D printed object to be repaired. The method may include evaluating, by moving the 3D printed object using the one or more robotic arms, an accessibility of the defective portion. The method may include determining, based on the accessibility of the defective portion, an orientation of the 3D printed object for repairing the defective portion. The method may include depositing material to create a localized secondary powder bed on the defective portion while the one or more robotic arms maintain the 3D printed object in the orientation. The method may include fusing the material of the localized secondary powder bed to the defective portion to repair the defective portion. The method may include removing excess material of the localized secondary powder bed after the defective portion is repaired.

Some aspects described herein relate to a computer system. The computer system may include a processor set, one or more computer-readable storage media, and program instructions stored on the one or more computer-readable storage media to cause the processor set to perform operations. The operations may include receiving a 3D printed object in a 3D printing system. The operations may include identifying a defective portion of the 3D printed object to be repaired. The operations may include determining, by moving the 3D printed object using the one or more robotic arms, a repair orientation of the 3D printed object for repairing the defective portion. The operations may include performing a deposition operation to deposit material to create a localized secondary powder bed on the defective portion while the one or more robotic arms maintain the 3D printed object in the repair orientation. The operations may include performing a fusing operation, using the 3D printing head, to fuse the material of the localized secondary powder bed to the defective portion to repair the defective portion. The operations may include performing a material removal operation to remove excess material of the localized secondary powder bed after the fusing operation. The operations may include repeating the deposition operation, the fusing operation, and the material removal operation for a plurality of cycles to repair the defective portion.

Some aspects described herein relate to a computer program product. The computer program product may include one or more computer-readable storage media and program instructions stored on the one or more computer-readable storage media to perform operations. The operations may include receiving a 3D printed object in a 3D printing system. The operations may include identifying a defective portion of the 3D printed object to be repaired. The operations may include evaluating, by moving the 3D printed object using the one or more robotic arms, an accessibility of the defective portion. The operations may include determining, based on the accessibility of the defective portion, an orientation of the 3D printed object for repairing the defective portion. The operations may include selecting, based on the orientation and based on one or more parameters of the defective portion, a repair type for repairing the defective portion. The operations may include performing, based on the repair type, a repair of the defective portion using a localized secondary powder bed.

### BRIEF DESCRIPTION OF THE DRAWINGS

FIG. 1 is a diagram of an example computing environment for supporting 3D printing.

FIG. 2 is a diagram of an example implementation of a 3D printing system.

FIG. 3 is a diagram of an example implementation of a 3D printing process.

FIGS. 4A-4F are diagrams of an example implementation of repairing a 3D printed object using a secondary powder fusion bed.

FIG. 5 is a diagram of an example implementation of repairing a 3D printed object using a secondary powder fusion bed.

FIG. 6 is a flowchart of an example process associated with repairing a 3D printed object using a secondary powder fusion bed.

FIG. 7 is a flowchart of an example process associated with repairing a 3D printed object using a secondary powder fusion bed.

FIG. 8 is a flowchart of an example process associated with repairing a 3D printed object using a secondary powder fusion bed.

### DETAILED DESCRIPTION

The following detailed description of example implementations refers to the accompanying drawings. The same reference numbers in different drawings may identify the same or similar elements.

Defects may occur during the 3D printing process, resulting in incomplete or defective 3D printed objects. These defects may be due to various process defects, such as material deposition rate, incomplete laser sintering, insufficient material provided in the area of the defect, and/or nonuniformities in the powder fusion bed of material from which the 3D printed object is formed. In some cases, the severity of a defect and/or the density or quantity of defects in a 3D printed object may result in the 3D printed object being scrapped and reprinted, which results in increased consumption of material, power, and processing resources of the 3D printing system that is used to print the 3D printed objects.

In some implementations described herein, a 3D printing system is configured to perform repairs of defects in 3D printed objects using a secondary powder fusion bed. For example, the 3D printing system may receive a 3D printed object and may analyze the 3D printed object to identify a defective portion of the 3D printed object that is to be repaired. With the defect identified, the 3D printing system may be equipped with one or more robotic arms that are used to evaluate the accessibility of the defective portion by manipulating the orientation of the 3D printed object using the robotic arm(s). This enables the 3D printing system to determine an orientation of the 3D printed object for repairing the defective portion based on the accessibility. With the repair orientation determined, the 3D printing system may deposit material to create a localized secondary powder bed in the area of defective portion while maintaining the 3D printed object in the repair orientation, and may fuse the material of the localized secondary powder bed to the defective portion to repair the defective portion.

In this way, the 3D printing system and techniques described herein may optimize the repair processes for 3D printed objects, reducing processing overhead, material usage, computing resource usage, and energy consumption associated with manufacturing 3D printed objects. The use of the robotic arm(s) to position a 3D printed object in particular orientations for repair facilitates the repair of complex 3D printed objects, as well as facilitates repair of 3D printed objects that have been assembled into a larger system without needing to disassemble the system. The capability to repair 3D printed objects reduces resource utilization (including powder material waste) relative to reprinting the 3D printed objects, thereby conserving processing resources, memory resources, and/or network resources of the 3D printing system.

Additionally and/or alternatively, the use of a localized secondary powder bed enables targeted repair of defective portions, reduces material consumption for repairing a 3D printed object, as well as minimizes unnecessary thermal loading and mechanically-induced stress on the 3D printed object, which can help to extend the lifespan of the object.

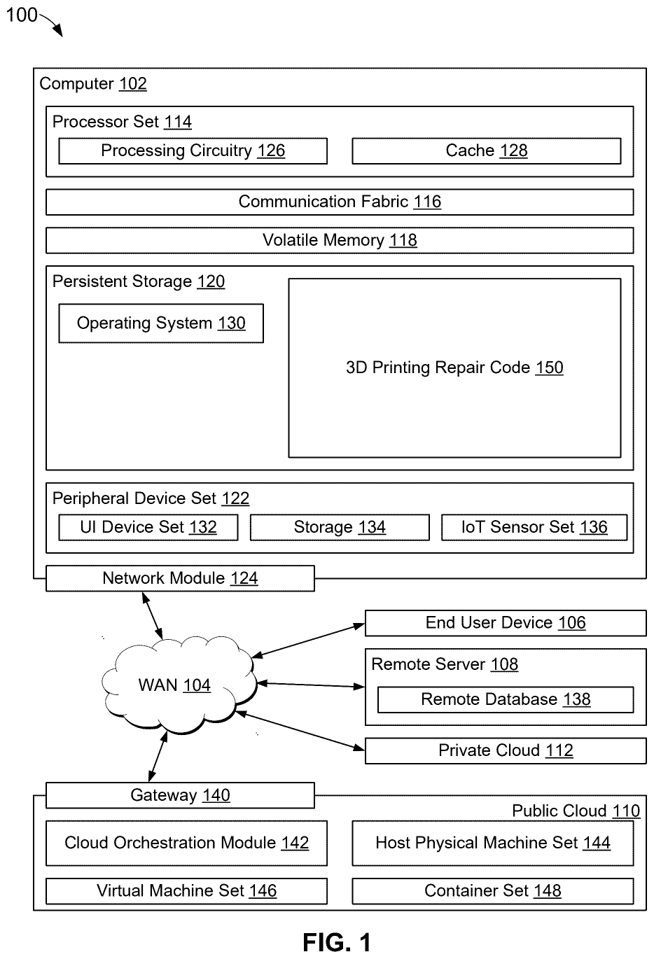

FIG. 1 is a diagram of an example computing environment 100 for supporting 3D printing.

The computing environment 100 contains an example of an environment for the execution of at least some of the computer code involved in performing the inventive methods, such as 3D printing repair code 150. In addition to the 3D printing repair code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the 3D printing repair code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in 3D printing repair code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the 3D printing repair code 150 typically includes at least some of the computer code involved in performing one or more operations described herein. In some implementations, the operations may include receiving a 3D printed object in a 3D printing system, where the 3D printing system includes one or more robotic arms; identifying a defective portion of the 3D printed object to be repaired; evaluating, by moving the 3D printed object using the one or more robotic arms, an accessibility of the defective portion; determining, based on the accessibility of the defective portion, an orientation of the 3D printed object for repairing the defective portion; depositing material to create a localized secondary powder bed on the defective portion while the one or more robotic arms maintain the 3D printed object in the orientation; fusing the material of the localized secondary powder bed to the defective portion to repair the defective portion; and removing excess material of the localized secondary powder bed after the defective portion is repaired.

In some implementations, the operations may include receiving a 3D printed object in a 3D printing system, where the 3D printing system includes one or more robotic arms; identifying a defective portion of the 3D printed object to be repaired; determining, by moving the 3D printed object using the one or more robotic arms, a repair orientation of the 3D printed object for repairing the defective portion, where a direct line of sight between the defective portion and a 3D printing head of a 3D printing system is achieved in the repair orientation; performing a deposition operation to deposit material to create a localized secondary powder bed on the defective portion while the one or more robotic arms maintain the 3D printed object in the repair orientation; performing a fusing operation, using the 3D printing head, to fuse the material of the localized secondary powder bed to the defective portion to repair the defective portion; performing a material removal operation to remove excess material of the localized secondary powder bed after the fusing operation; and repeating the deposition operation, the fusing operation, and the material removal operation for a plurality of cycles to repair the defective portion.

In some implementations, the operations may include receiving a 3D printed object in a 3D printing system, where the 3D printing system comprises one or more robotic arms; identifying a defective portion of the 3D printed object to be repaired; evaluating, by moving the 3D printed object using the one or more robotic arms, an accessibility of the defective portion; determining, based on the accessibility of the defective portion, an orientation of the 3D printed object for repairing the defective portion; selecting, based on the orientation and based on one or more parameters of the defective portion, a repair type for repairing the defective portion; and performing, based on the repair type, a repair of the defective portion using a localized secondary powder bed.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

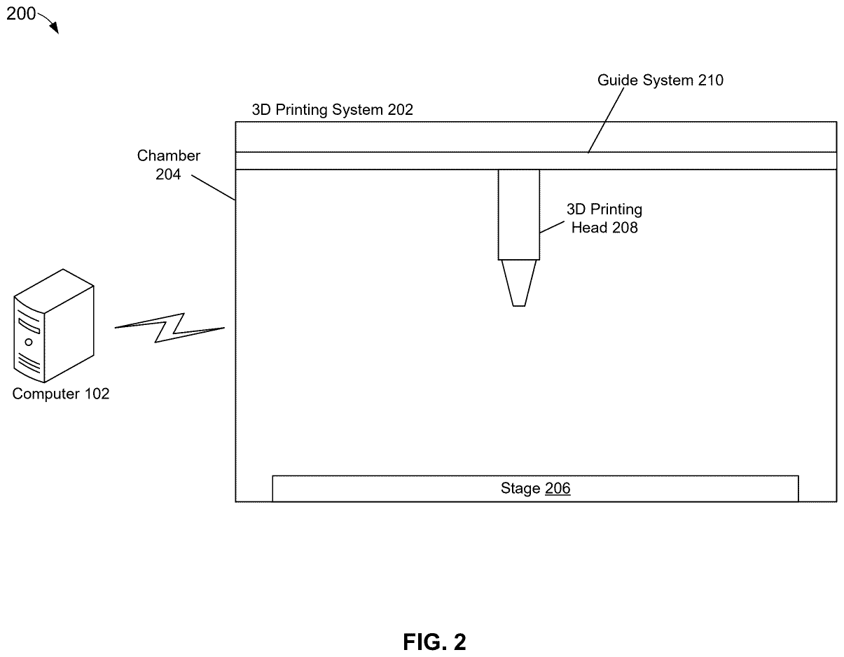

FIG. 2 is a diagram of an example implementation 200 of a 3D printing system 202. The 3D printing system 202 may be configured to 3D print objects using one or more 3D printing techniques, such as fused deposition, stereolithography, binder jetting, and/or powder bed fusion, among other examples. The objects that can be 3D printed by such 3D printing system 202 are not limited to any particular type of object, and may include industrial components, consumer components, and/or other types of components.

As shown in FIG. 2, the 3D printing system 202 may include a chamber 204 and a stage 206 within the chamber 204. A 3D printing head 208 may be located within the chamber 204 above the stage 206. The 3D printing head 208 may be coupled to a guide system 210 that enables the 3D printing head 208 to be moved and selectively positioned using computer numerical control (CNC).

The chamber 204 may include an internal volume and may include one or more sides that enclose the internal volume. Alternatively, one or more sides of the chamber 204 may be omitted such that the internal volume of the chamber is open an accessible.

In some implementations, the stage 206 includes a base plate, a chamber floor, a platen, and/or another type of horizontal surface that is configured to support and provide a substrate on which an object is 3D printed.

In some implementations, the stage 206 is a build platform that is surrounded by walls to define a volume in which a powder bed may be contained. A powder stock and powder roller may be located adjacent to the build platform and may be configured to provide additional layers of powder to the powder bed for 3D printing. The build platform may be configured to be raised and/or lowered as layers of an object are 3D printed.

In some implementations, the 3D printing head 208 is configured to provide the additive material for 3D printing an object. For example, the 3D printing head 208 may include a material jet, a material extrusion nozzle, and/or another type of head through which material is deposited onto the stage 206 (or onto an object that is being 3D printed on the stage 206).

In some implementations, the 3D printing head 208 is a fusion source that fuses material to an object that is being 3D printed. For example, the 3D printing head 208 may include a laser head that melts or sinters material of a powder bed on the stage 206 to fuse powder from the powder bed to the object being 3D printed. As another example, the 3D printing head 208 may include a laser head that cures a resin to solidify the resin to ad material to an object being 3D printed.

The guide system 210 may include a combination of belts, gears, motors, structures, and/or other components that enable the 3D printing head 208 to be moved according to a programmed path. In some implementations, the guide system 210 includes a gantry to which the 3D printing head 208 is mounted. The computer 102 may control the movement of the 3D printing head 208 along the gantry by CNC programming.

As further shown in FIG. 2, the computer 102 may be communicatively coupled to the 3D printing system 202 and may control various aspects of the operation of the 3D printing system 202 and/or the components included therein. The computer 102 may be a part of the 3D printing system 202 and may correspond to the control system of the 3D printing system 202. In some implementations, the computer 102 is embedded in the form factor of the 3D printing system 202. In some implementations, the computer 102 is located remote from the 3D printing system 202.

The computer 102 may communicate with components of the 3D printing system 202 over wired and/or wireless communication links using the network module 124 and/or the communication fabric 116, among other examples. The computer 102 may communicate with components of the 3D printing system 202 to control various aspects of the operation of the 3D printing system 202 to 3D print an object and/or to repair the object.

FIG. 2 is provided as an example. Other examples may differ from what is described with regard to FIG. 2.

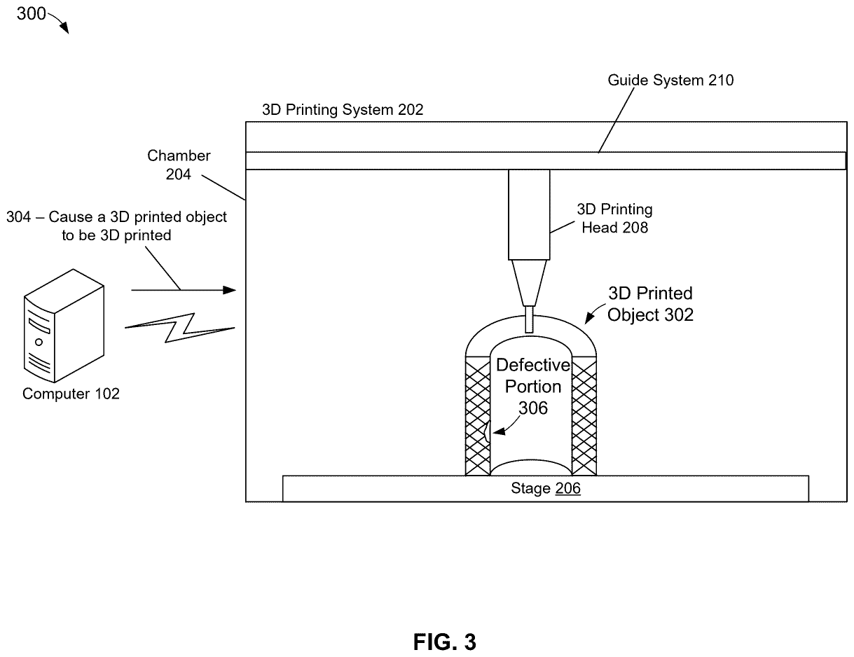

FIG. 3 is a diagram of an example implementation 300 of a 3D printing process. As shown in FIG. 3, the 3D printing process may be performed to 3D print a 3D printed object 302 using the 3D printing system 202. The 3D printed object 302 is not limited to any particular type of object, and may include industrial components, consumer components, and/or other types of components.

As shown in FIG. 3, at 304, the computer 102 may provide one or more signals to the 3D printing system 202 to cause the 3D printing system 202 to 3D print the 3D printed object 302. 3D printing the 3D printed object 302 may include dispensing or depositing material through the 3D printing head 208 onto the stage 206 to build up the 3D printed object 302 layer by layer. Additionally and/or alternatively, the stage 206 may include a powder fusion bed of material, and the 3D printing head 208 may emit a laser beam or ultraviolet (UV) radiation beam that is used to sinter or cure the material to build up the 3D printed object 302 layer by layer.

In some implementations, the computer 102 may the provide one or more signals to the 3D printing system 202 to cause the 3D printing system 202 to 3D print the layer of the 3D printed object 302 based on a set of printing parameters. For example, the signal(s) may cause the guide system 210 of the 3D printing system 202 to move the 3D printing head 208 along the movement path determined for the set of printing parameters. As another example, the signal(s) may cause the 3D printing head 208 to dispense material at a rate that was determined for the set of printing parameters. As another example, the signal(s) may cause the 3D printing head 208 to emit a laser beam at a power level that was determined for the set of printing parameters.

The computer 102 may determine the set of printing parameters for 3D printing a layer of the 3D printed object 302. The set of printing parameters may include a printing speed for the layer, a movement path for the 3D printing head 208 for printing the layer, a material deposition rate for the 3D printing head 208, a power level (e.g., a laser power level) for the 3D printing head 208, and/or a type of material that is to be deposited, among other examples. In some implementations, one or more of the printing parameters is based on the shape, geometry, size, orientation, and/or complexity of the 3D printed object 302 that is to be printed. For example, the printing speed may be based on the size of the 3D printed object 302 and/or the shape of the 3D printed object 302. As another example, the power level of the laser beam may be based on the type of material from which the 3D printed object 302 is formed.

As further shown in FIG. 3, defects may occur in the 3D printed object 302 from the 3D printing operation. A defective portion 306 in the 3D printed object 302 may correspond to a portion of the 3D printed object 302 that was not fully formed according to a 3D model or design for the 3D printed object 302. In other words, the defective portion 306 is an incomplete portion (e.g., a recess, a crater, a divot) of the 3D printed object 302 that is missing material that was intended to be formed during the 3D printing operation. The defect portion 306 may occur because of various process defects, such as material deposition rate, incomplete laser sintering, and/or insufficient material provided in the area of the defective portion 306, among other examples. For example, the defect portion 306 may occur due to insufficient material being deposited by the 3D printing head 208 in the area of the defective portion 306 (e.g., due to too low of a material dispensing rate, due to a clog in the 3D printing head 208, due to too fast of movement speed of the 3D printing head 208). As another example, the defect portion 306 may occur because the power level of the laser beam emitted by the 3D printing head 208 was insufficient to sinter a sufficient amount of material to fully form the 3D printed object 302 in the defective portion 306. As another example, the defect portion 306 may occur because of nonuniformities in the powder fusion bed of material from which the 3D printed object 302 is formed. This may be due to clumping, low spots, and/or other inconsistencies in the powder fusion bed.

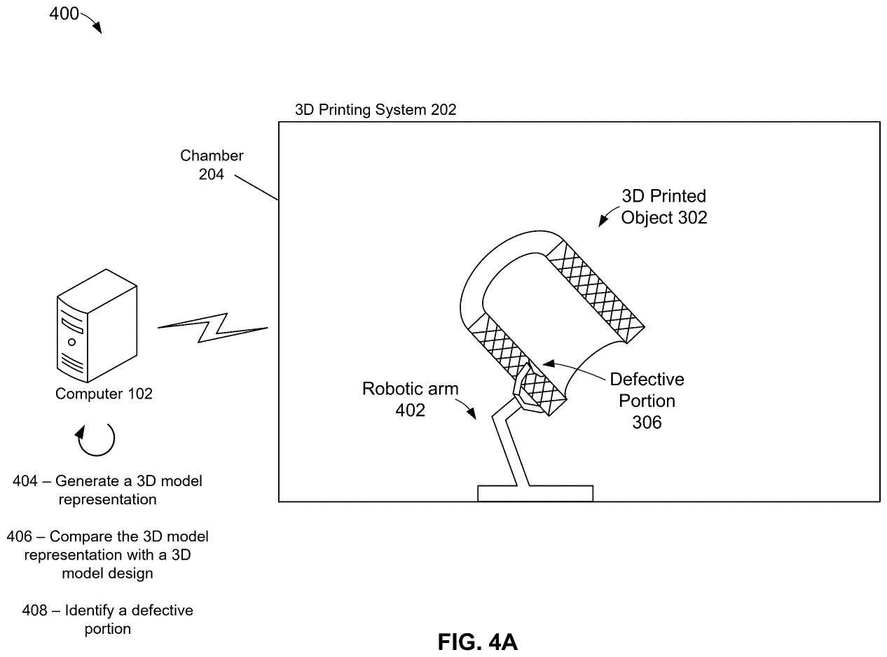

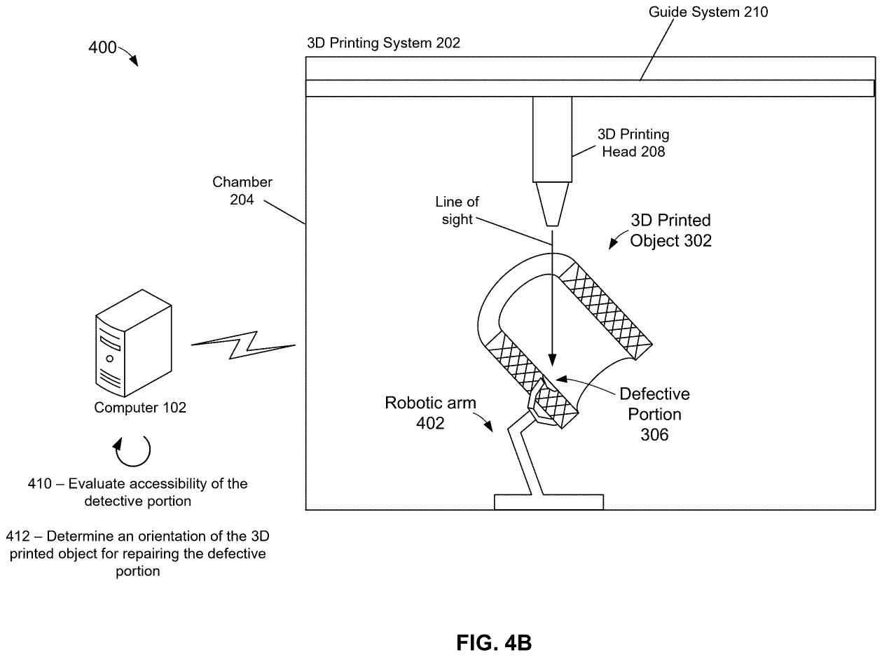

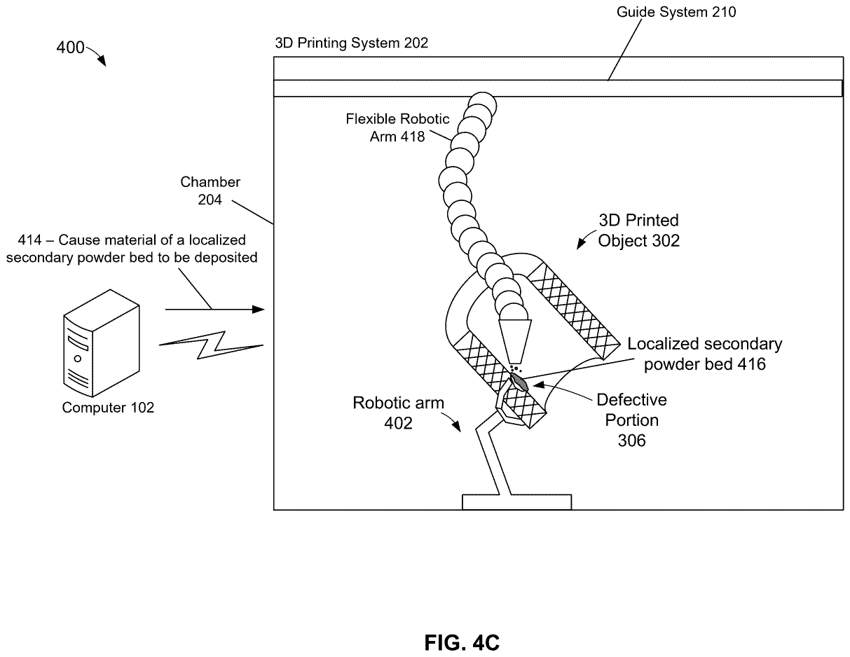

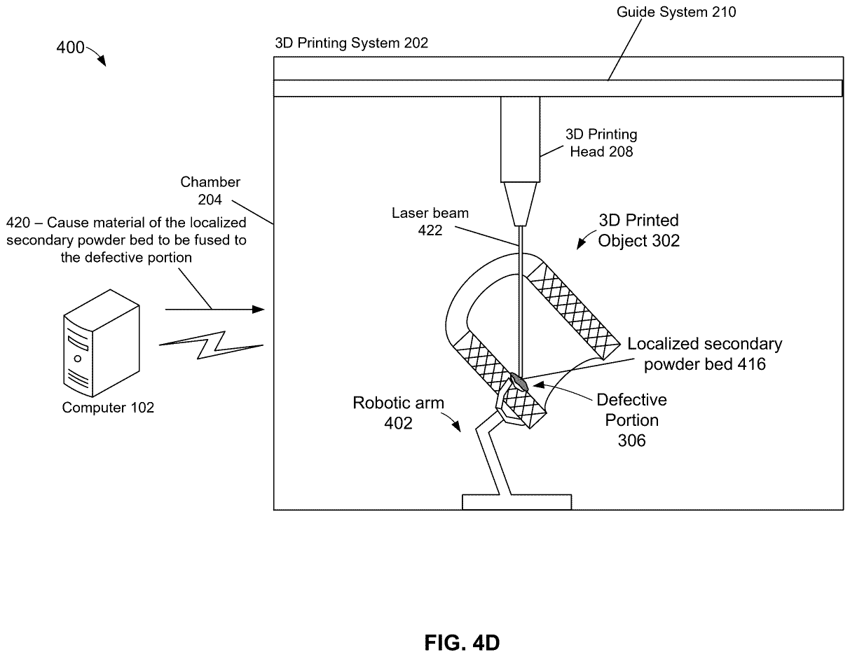

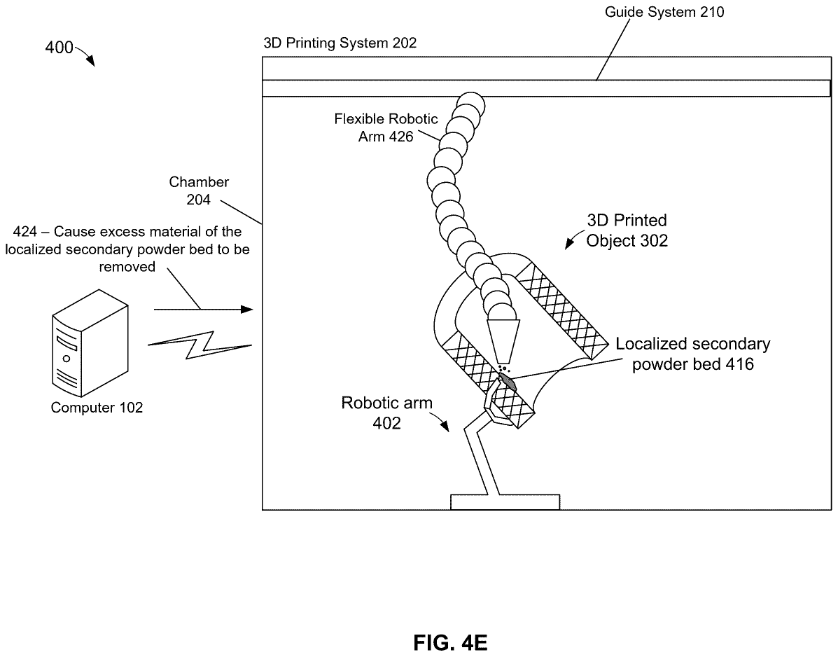

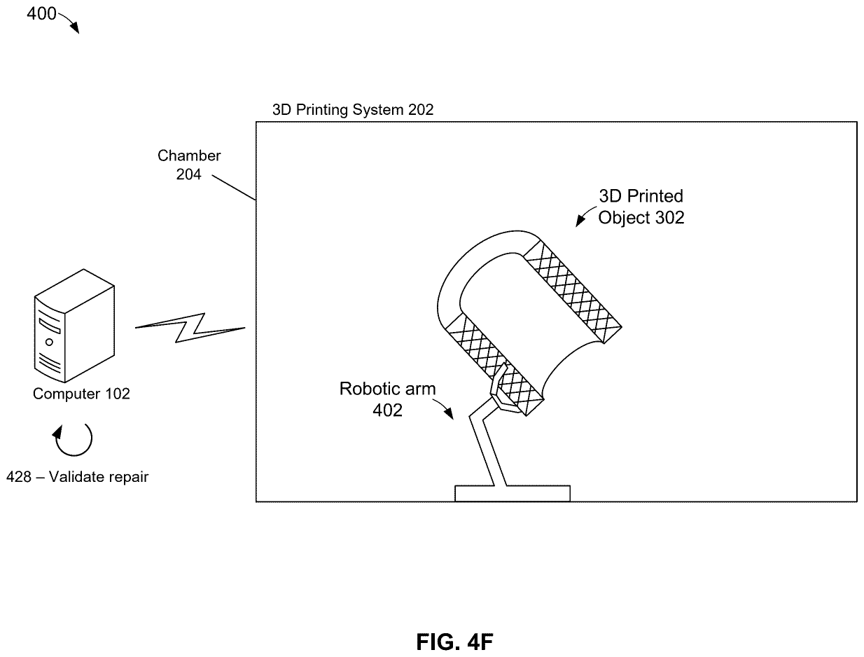

FIGS. 4A-4F, 5, 6, 7, and/or 8 describe various techniques that can be used to repair the defective portion 306 using a secondary powder fusion bed of material. As described in greater detail in connection with those figures, the secondary powder fusion bed of material may be formed around the defective portion 306 to fill in the defective portion 306. The secondary powder fusion bed may be localized in that the secondary powder fusion bed is formed around the local region of the defective portion 306 (e.g., as opposed to fully submerging the 3D printed object 302 in another powder fusion bed). The formation and fusing of the secondary powder fusion bed may be facilitated by additional components of the 3D printing system 202 illustrated and described in connection with FIGS. 4A-4F.

FIG. 3 is provided as an example. Other examples may differ from what is described with regard to FIG. 3.

FIGS. 4A-4F are diagrams of an example implementation 400 of repairing a 3D printed object using a secondary powder fusion bed. In particular, the example implementation 400 includes an example of repairing the defective portion 306 of the 3D printed object 302 using a secondary powder fusion bed. In some implementations, the repair process described in connection with FIGS. 4A-4F is performed after 3D printing of the 3D printed object 302 is completed. In these implementations, the computer 102 may determine that the defective portion 306 is to be repaired after 3D printing of the 3D printed object 302 is completed. In some implementations, the computer 102 determines that defective portion 306 is to be repaired prior to 3D printing of the 3D printed object 302 being complete. In other words, 3D printing of the 3D printed object 302 may be interrupted to repair the defective portion 306 of the 3D printed object 302 before resuming 3D printing of the 3D printed object 302 after the repair. In some implementations, the computer 102 executes the 3D printing repair code 150 to perform one or more operations described in the example implementation 400.

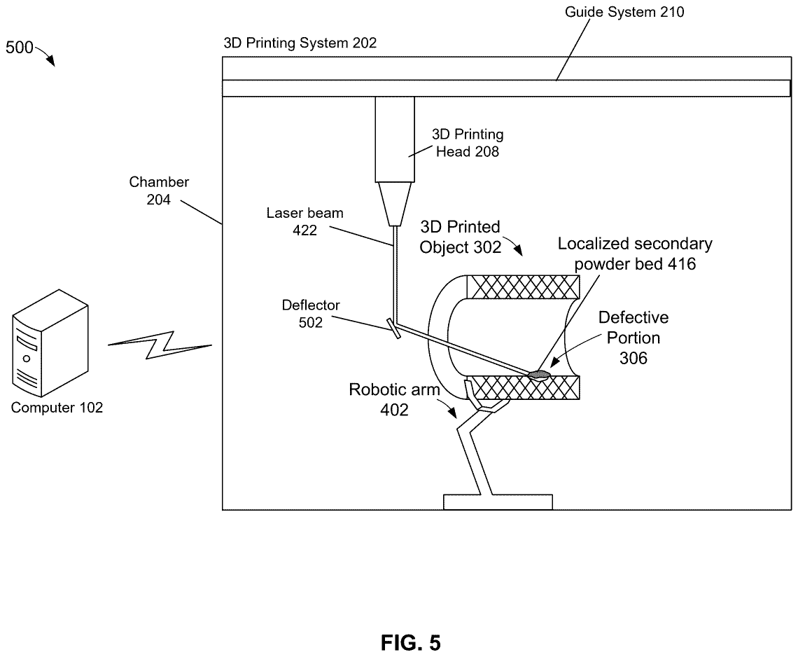

As shown in FIG. 4A, the 3D printing system 202 may include one or more robotic arms 402. While one robotic arm 402 is shown in FIGS. 4A-4F and 5, other quantities of robotic arms 402 for the 3D printing system 202 are within the scope of the present disclosure.

As further shown in FIG. 4A, a robotic arm 402 may be configured to secure the 3D printed object 302 and to manipulate or modify the orientation of the 3D printed object 302. The robotic arm 402 may include a gripping mechanism, such as a claw, for gripping and securing the 3D printed object 302. The robotic arm 402 may also include various beams, an adjustable base, and/or other structural components that enable the robotic arm 402 to change the orientation and/or position of the 3D printed object 302. For example, the robotic arm 402 may be configured to rotate, translate, and/or otherwise move the 3D printed object 302. The robotic arm 402 may be used to move the 3D printed object 302 for evaluation of the 3D printed object 302, and/or for positioning and/or orienting the 3D printed object 302 for repair of the defective portion 306, among other examples. The robotic arm 402 may include a tracking system of cameras, laser scanners, or other tracking components that generate data that the robotic arm 402 and/or the computer 102 can use to determine the position and/or orientation of the 3D printed object 302 when it is mounted on the robotic arm 402.

As further shown in FIG. 4A, at 404, the computer 102 may generate a 3D model representation of the 3D printed object 302 as part of the repair procedure. At 406, the computer 102 may compare the 3D model representation to a 3D model design of the 3D printed object 302 to identify the defective portion 306 at 408. If there are multiple defective portions 306 on the 3D printed object 302, the computer 102 may identify each of the multiple defective portions 306 and their locations on the 3D printed object 302.

The 3D printing system 202 may include 3D scanning devices, such as laser scanners and/or structured light scanners, among other examples. The computer 102 may provide one or more signals to the scanners to capture images, video, infrared signals, and/or other types of data to generate a detailed 3D digital model representation of the entire 3D printed object 302, including the defective area.

As further shown in FIG. 4A, at 406, the computer 102 may compare the 3D model representation to a 3D model design for the 3D printed object 302 to inspect the 3D printed object 302 for defects. The computer 102 may use various image processing techniques and/or computer vision techniques to detect and segment the defective portion 306 within the 3D model representation.

As further shown in FIG. 4A, at 408, the computer 102 may identify the defective portion 306 based on the comparison of the 3D model representation and the 3D model design. For example, the computer 102 may identify a portion of the 3D model design that is not present in the 3D model representation, indicating incomplete formation of a portion of the 3D printed object 302. As another example, the computer 102 may identify a portion of the 3D model representation that includes a crack that is not present in the 3D model design. As another example, the computer 102 may identify a portion of the 3D model representation that has dimensions that are not within design or manufacturing tolerances of the dimensions for the portion in the 3D model design.

Based on the identified types of defects, the computer 102 may classify the detected defects based on their severity. The severity of the defective portion 306 may be based on the size of the defective portion 306 (e.g., the surface area of the defective portion 306, the depth of the defective portion 306), the shape of the defective portion 306, the defect type (e.g., whether the defect is a crack or a portion of missing material), the location of the defective portion 306 (e.g., whether the defective portion 306 is located in an area of the 3D printed object 302 that is non-functional or estimated to experience high stresses during operation of the 3D printed object 302), and/or based on other parameters associated with the defective portion 306 and/or the 3D printed object 302.

The computer 102 may determine a type of repair to perform on the 3D printed object 302 to repair the defective portion 306. The repair type may be based on the material of the 3D printed object 302, the severity of the defective portion 306, the location of the defective portion 306, the 3D printing technique that was used to manufacture the 3D printed object 302, and/or based on another factor. The computer 102 may store information associated with different capabilities of different repair techniques (e.g., in a knowledgebase in the persistent storage 120), and the computer 102 may determine the repair type based on the capabilities of the different repair types.

As shown in FIG. 4B, at 410, the computer 102 may evaluate the accessibility of the defective portion 306 for the selected repair type. For example, the computer 102 may select a powder fusion repair technique, and the computer 102 may evaluate the accessibility of the defective portion 306 for powder fusion repair based on the relative position of the defective portion 306.

To evaluate the accessibility of the defective portion 306, the computer 102 may determine whether a line of site between the 3D printing head 208 and the defective portion 306 can be achieved for the repair. The computer 102 may cause the robotic arm(s) 402 to move the 3D printed object 302 and/or the 3D printing head 208 to determine whether a line of site between the 3D printing head 208 and the defective portion 306 can be achieved for the repair.

As further shown in FIG. 4B, at 412, the computer 102 may determine an orientation of the 3D printed object 302 for repairing the defective portion 306 (e.g., based on determining that the defective portion 306 is accessible for the repair). The computer 102 may determine the orientation based on the position of the defective portion 306 and the direction of the 3D printing head 208 laser beam path, among other examples.

To determine the orientation, the computer 102 may generate a simulation of the repair to generate an accessibility map that visually highlights the regions of the defective portion 306. The computer 102 may simulate the process of creating a powder bed layer by layer, taking into consideration repair factors such as the effect of gravity on the ability to deposit and retain powder material effectively around the defective portion 306. The computer 102 may analyze each layer of the powder bed to determine if any portion of the defective portion 306 is challenging to reach or cover with powder material in a candidate orientation. The computer 102 may perform a trial-and-error approach, where the computer 102 iterates through a plurality of candidate orientations, simulating the effectiveness of the repair in each candidate orientation using machine learning and/or artificial intelligence. For example, the computer 102 may use a machine learning model that was trained on 3D printed object repairs (e.g., thousands of repair operations, hundreds of thousands of repair operations) and may provide the candidate orientation and other parameters such as the size/shape of the defective portion 306 and the location of the defective portion 306 as inputs to the machine learning model. The computer 102 may use the machine learning model to generate an output that indicates an estimated effectiveness of the repair and the likelihood of success of the repair in the candidate orientation.

In some implementations, the computer 102 may first attempt to achieve an approximately perpendicular orientation between the defective portion 306 and the 3D printing head 208. In the perpendicular orientation, a line of sight between the defective portion 306 and the 3D printing head 208 may be achieved while recess or crack of the defective portion 306 is oriented such that gravity may effectively retain material of a powder bed in the defective portion 306. If no line of site can be achieved in the perpendicular orientation, the computer 102 may cause the robotic arm(s) 402 to modify the orientation of the 3D printed object 302 until a line of sight can be achieved, and then the computer 102 may analyze the orientation to determine if the repair can be completed effectively. Moreover, the computer 102 may determine parameters for the repair in the orientation, such as laser power, powder bed size, and/or the direction from which material of the powder bed is to be deposited, among other examples.

In some implementations, based on the types of the defects, the computer 102 may prioritize the identified defects based on factors such as criticality, location, and/or the ease of access for repair. The computer 102 may determine the order in which repairs should be conducted for repairing a plurality of defects.

In some implementations, based on the simulation of the line of sight of the defect position, and the laser beam direction, the computer 102 may identify how the robotic arm 402 will change the orientation of the 3D printed object 302. In some implementations, based on the simulation of the line of sight of the defect with the laser beam, the computer 102 may identify how the robotic arm 402 will change the alignment of the defective portion 306 and the 3D printing head 208, which may involve rotating the 3D printed object 302 and/or the robotic arm 402 so that the laser beam can perform powder fusion.

As shown in FIG. 4C, at 414, the computer 102 may provide one or more signals to the 3D printing system 202 to cause the 3D printing system 202 to deposit material of a localized secondary powder bed 416 in the area of the defective portion 306. The localized secondary powder bed 416 is localized in that the material of the localized secondary powder bed 416 is formed only in the area of the defective portion 306, as opposed to forming a secondary powder bed around the entire 3D printed object 302. The localized secondary powder bed 416 is a secondary powder bed in that a primary powder bed may be used to 3D print the 3D printed object 302 in the example implementation 300 in FIG. 3.

In some implementations, the 3D printing system 202 includes a flexible robotic arm 418 that is capable of depositing material in various orientations and positions. The flexibility of the flexible robotic arm 418 provides for increased flexibility in inserting the flexible robotic arm 418 in tight and/or hard to reach areas of the 3D printed object 302. Based on the identified defective portion 306, the flexible robotic arm 418 may deposit material in and/or around the defective portion 306 to create the localized secondary powder bed 416 while the robotic arm(s) 402 maintain the 3D printed object 302 in the determined orientation for repair.

In some implementations, the flexible robotic arm 418 deposits material in and/or around the defective portion 306 to create the localized secondary powder bed 416 based on one or more parameters of the defective portion 306. For example, the computer 102 may determine, based on one or more parameters of the defective portion 306 (e.g., the surface area of the defective portion 306, the depth of the defective portion 306, the severity of the defective portion 306, the orientation of the defective portion 306), one or more dimensions and a shape for the localized secondary powder bed 416. The computer 102 may cause the flexible robotic arm 418 to deposit the material to create the localized secondary powder bed based on the dimensions and shape determined for the localized secondary powder bed

As shown in FIG. 4D, at 420 the compute 102 may provide one or more signals to the 3D printing system 202 to cause the 3D printing system to fuse material of the localized secondary powder bed 416 to the 3D printed object 302 to repair the defective portion 306. In particular, the signals may cause the 3D printing system 202 to align the 3D printing head 208 with the defective portion 306 using the guide system 210, and to cause the 3D printing head 208 to emit a laser beam 422 to sinter the material of the localized secondary powder bed 416 to fuse the material to the defective portion 306. This enables the material to fill in the crack or divot of the defective portion 306.

As shown in FIG. 4E, at 424, the computer 102 may provide one or more signals to the 3D printing system 202 to cause the 3D printing system 202 to remove excess material of the localized secondary powder bed 416. In some implementations, the 3D printing system 202 may remove excess material of the localized secondary powder bed 416 after the defective portion 306 is repair. In some implementations, the defective portion 306 is repaired by performing a plurality of cycles of creating a localized secondary powder bed 416, fusing the material of the localized secondary powder bed 416 to the defective portion 306, and removing remaining material of the localized secondary powder bed 416 after fusion to repair the defective portion 306 layer by layer. In these implementations, the 3D printing system 202 may remove excess material of the localized secondary powder bed 416 after each fusion cycle so that a subsequent localized secondary powder bed 416 may be formed with a fresh batch of material.

The computer 102 may select the material for the localized secondary powder bed 416 such that the material is capable of being removed. For example, the computer 102 may select a material for the repair such that the localized secondary powder bed 416 is fragile and/or can be dissolved or melted away so that unused powder material of the localized secondary powder bed 416 can be recovered without damaging the 3D printed object 302.

In some implementations, the 3D printing system 202 includes a flexible robotic arm 426 that includes a vacuum head. The signals provided to the 3D printing system 202 from the computer 102 may cause the 3D printing system 202 to position the flexible robotic arm 426 using the guide system 210 such that the vacuum head is positioned near the localized secondary powder bed 416 to vacuum the remaining material of the localized secondary powder bed 416. In some implementations, the signals provided to the 3D printing system 202 from the computer 102 may cause the 3D printing system 202 to move the vacuum head of the flexible robotic arm 426 around the defective portion 306 to vacuum the remaining material of the localized secondary powder bed 416.

In some implementations, the signals provided to the 3D printing system 202 from the computer 102 may cause the 3D printing system 202 to use the robotic arm(s) 402 to move the 3D printed object 302 so that residual material of the localized secondary powder bed 416 falls off of the 3D printed object 302. The signals provided to the 3D printing system 202 from the computer 102 may cause the 3D printing system 202 to vacuum the material that fell from the 3D printed object 302 using the flexible robotic arm 426.

As shown in FIG. 4F, at 428, the computer 102 may validate the repair to determine whether the repair process was successful in repairing the defective portion 306. To validate the repair, the computer 102 may perform similar operations as described in connection with FIG. 4A to generate a 3D model representation of the 3D printed object 302 and compare the 3D model representation to the 3D model design of the 3D printed object 302. Here, the computer 102 may verify that the dimensions of the 3D printed object 302 (as represented in the 3D model representation) are within design and manufacturing tolerances of the 3D model design, and if so, the computer 102 may determine that the repair process was successful in repairing the defective portion 306.

In some implementations, the computer 102 may compare only the section of the 3D model representation in which the defective portion 306 was located to validate the repair. In some implementations, the computer 102 may compare the entire 3D model representation to the 3D model design to ensure that no other defects were caused during the repair process. If additional defects were formed, the operations described in connection with FIGS. 4B-4F may be performed to repair those defects and to validate the repair(s).

FIGS. 4A-4F are provided as an example. Other examples may differ from what is described with regard to FIGS. 4A-4F.

FIG. 5 is a diagram of an example implementation 500 of repairing a 3D printed object using a secondary powder fusion bed. As shown in FIG. 5, the example implementation 500 is similar to the example implementation 400. However, in the example implementation 500, the laser beam 422 is used to indirectly sinter the material of the localized secondary powder bed 416 to repair the defective portion 304. This may be implemented using a deflector 502, which may be a mirror and/or another type of device that is capable of redirecting electromagnetic radiation (e.g., laser beams, UV beams).

The use of indirect sintering of the material of the localized secondary powder bed 416 to repair the defective portion 306 provides for greater flexibility in positioning and/or orienting the 3D printed object 302 for repairing the defective portion 306 using the localized secondary powder bed 416. For example, in some use cases, the 3D printed object 302 may be oriented using the robotic arm 402 in an orientation that prioritizes positioning the defective portion 306 for more effective accumulation and retention of material of the localized secondary powder bed 416 in and/or around the defective portion 306 than if a direct path were used for fusing the material to the defective portion 306.

In some implementations, the computer 102 determines whether a direct path for the laser beam 422 can be achieved for a suitable orientation of the 3D printed object 302 for the repair. If the computer 102 determines that the repair cannot be effectively completed, or if the estimated effectiveness of the repair using a direct path for the laser beam 422 is determined to not satisfy a threshold probability, the computer 102 may determine an orientation of the 3D printed object 302 for the repair in which the deflector 502 is used to access the defective portion 306 via an indirect path for the laser beam 422. In some implementations, the computer 102 determines that the defective portion 306 may be inaccessible via a direct path for the laser beam 422, and the computer 102 may determine an orientation of the 3D printed object 302 for the repair in which the deflector 502 is used to access the defective portion 306 via an indirect path for the laser beam 422 to enable the defective portion 306 to be accessed by the laser beam 422 via the indirect path to complete the repair.

FIG. 5 are provided as an example. Other examples may differ from what is described with regard to FIG. 5.

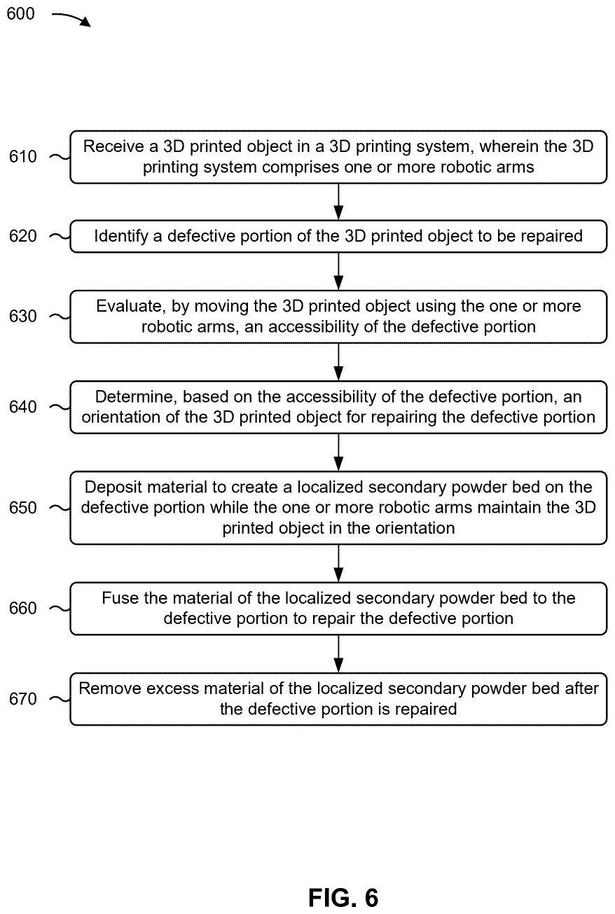

FIG. 6 is a flowchart of an example process 600 associated with repairing a 3D printed object using a secondary powder fusion bed. One or more process blocks of FIG. 6 are performed by a 3D printing system (e.g., 3D printing system 202) and/or by another device or a group of devices separate from or including the 3D printing system, such as a computer (e.g., computer 102). Additionally, or alternatively, one or more process blocks of FIG. 6 may be performed by one or more components of the computer 102, such as the processor set 114, the communication fabric 116, the volatile memory 118, the persistent storage 120, the peripheral device set 122, and/or the network module 124, among other examples. In some implementations, the processor set 114 of the computer 102 may execute the 3D printing repair code 150 to perform one or more of the operations of the example process 600.

As shown in FIG. 6, process 600 includes receiving a 3D printed object in a 3D printing system (block 610). For example, the 3D printing system may receive a 3D printed object in a 3D printing system, as described herein. In some implementations, the 3D printing system includes one or more robotic arms.

As further shown in FIG. 6, process 600 includes identifying a defective portion of the 3D printed object to be repaired (block 620). For example, the 3D printing system may identify a defective portion of the 3D printed object to be repaired, as described herein.

As further shown in FIG. 6, process 600 includes evaluating, by moving the 3D printed object using the one or more robotic arms, an accessibility of the defective portion (block 630). For example, the 3D printing system may evaluate, by moving the 3D printed object using the one or more robotic arms, an accessibility of the defective portion, as described herein.

As further shown in FIG. 6, process 600 includes determining, based on the accessibility of the defective portion, an orientation of the 3D printed object for repairing the defective portion (block 640). For example, the 3D printing system may determine, based on the accessibility of the defective portion, an orientation of the 3D printed object for repairing the defective portion, as described herein.

As further shown in FIG. 6, process 600 includes depositing material to create a localized secondary powder bed on the defective portion while the one or more robotic arms maintain the 3D printed object in the orientation (block 650). For example, the 3D printing system may deposit material to create a localized secondary powder bed on the defective portion while the one or more robotic arms maintain the 3D printed object in the orientation, as described herein.

As further shown in FIG. 6, process 600 includes fusing the material of the localized secondary powder bed to the defective portion to repair the defective portion (block 660). For example, the 3D printing system may fuse the material of the localized secondary powder bed to the defective portion to repair the defective portion, as described herein.

As further shown in FIG. 6, process 600 includes removing excess material of the localized secondary powder bed after the defective portion is repaired (block 670). For example, the 3d printing system may remove excess material of the localized secondary powder bed after the defective portion is repaired, as described herein.

Process 600 may include additional aspects, such as any single aspect or any combination of aspects described below and/or in connection with one or more other processes described elsewhere herein.

In a first aspect, determining the orientation of the 3D printed object for repairing the defective portion includes determining an orientation of the 3D printed object in which a line of sight between the defective portion and a 3D printing head of a 3D printing system is achieved.

In a second aspect, alone or in combination with the first aspect, identifying the defective portion includes scanning the 3D printed object to generate a 3D model representation of the 3D printed object, and comparing the 3D model representation of the 3D printed object with a 3D model design of the 3D printed object to identify the defective portion.

In a third aspect, alone or in combination with one or more of the first and second aspects, process 600 includes selecting the material based on the material being compatible with a powder fusion process for fusing the material to the defective portion.

In a fourth aspect, alone or in combination with one or more of the first through third aspects, process 600 includes selecting the material so that the excess material is removable without damaging the 3D printed object.

In a fifth aspect, alone or in combination with one or more of the first through fourth aspects, depositing the material to create the localized secondary powder bed includes determining, based on one or more parameters of the defective portion, dimensions and shape for the localized secondary powder bed, and depositing the material to create the localized secondary powder bed based on the dimensions and shape determined for the localized secondary powder bed.

In a sixth aspect, alone or in combination with one or more of the first through fifth aspects, determining the dimensions and shape for the localized secondary powder bed includes simulating the repair of the defective portion using machine learning to determine the dimensions and shape for the localized secondary powder bed.

In a seventh aspect, alone or in combination with one or more of the first through sixth aspects, depositing the material to create the localized secondary powder bed includes depositing the material using a flexible robot material delivery system to create the localized secondary powder bed.

In an eighth aspect, alone or in combination with one or more of the first through seventh aspects, fusing the material of the localized secondary powder bed to the defective portion to repair the defective portion includes applying a laser beam from a 3D printing head of a 3D printing system to the material of the localized secondary powder bed to fuse the material of the localized secondary powder bed to the defective portion.

In a ninth aspect, alone or in combination with one or more of the first through eighth aspects, applying the laser beam to the material of the localized secondary powder bed includes applying the laser beam to the material of the localized secondary powder bed in a direct line of sight between the 3D printing head and the defective portion.

In a tenth aspect, alone or in combination with one or more of the first through ninth aspects, applying the laser beam to the material of the localized secondary powder bed includes applying, using a deflector, the laser beam to the material of the localized secondary powder bed along an indirect path between the 3D printing head and the defective portion.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

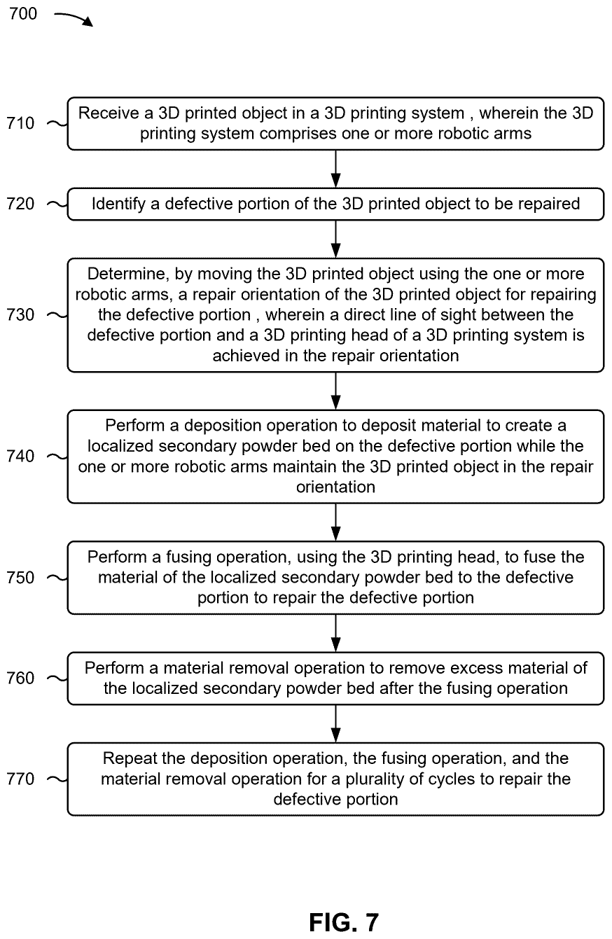

FIG. 7 is a flowchart of an example process 700 associated with repairing a 3D printed object using a secondary powder fusion bed. One or more process blocks of FIG. 7 are performed by a 3D printing system (e.g., 3D printing system 202) and/or by another device or a group of devices separate from or including the 3D printing system, such as a computer (e.g., computer 102). Additionally, or alternatively, one or more process blocks of FIG. 7 may be performed by one or more components of the computer 102, such as the processor set 114, the communication fabric 116, the volatile memory 118, the persistent storage 120, the peripheral device set 122, and/or the network module 124, among other examples. In some implementations, the processor set 114 of the computer 102 may execute the 3D printing repair code 150 to perform one or more of the operations of the example process 700.

As shown in FIG. 7, process 700 includes receiving a 3D printed object in a 3D printing system (block 710). For example, the 3D printing system may receive a 3D printed object in a 3D printing system, as described herein. In some implementations, the 3D printing system includes one or more robotic arms.

As further shown in FIG. 7, process 700 includes identifying a defective portion of the 3D printed object to be repaired (block 720). For example, the 3D printing system may identify a defective portion of the 3D printed object to be repaired, as described herein.

As further shown in FIG. 7, process 700 includes determining, by moving the 3D printed object using the one or more robotic arms, a repair orientation of the 3D printed object for repairing the defective portion (block 730). For example, the 3D printing system may determine, by moving the 3D printed object using the one or more robotic arms, a repair orientation of the 3D printed object for repairing the defective portion, as described herein. In some implementations, a direct line of sight between the defective portion and a 3D printing head of a 3D printing system is achieved in the repair orientation.

As further shown in FIG. 7, process 700 includes performing a deposition operation to deposit material to create a localized secondary powder bed on the defective portion while the one or more robotic arms maintain the 3D printed object in the repair orientation (block 740).

For example, the 3D printing system may perform a deposition operation to deposit material to create a localized secondary powder bed on the defective portion while the one or more robotic arms maintain the 3D printed object in the repair orientation, as described herein.

As further shown in FIG. 7, process 700 includes performing a fusing operation, using the 3D printing head, to fuse the material of the localized secondary powder bed to the defective portion to repair the defective portion (block 750). For example, the 3D printing system may perform a fusing operation, using the 3D printing head, to fuse the material of the localized secondary powder bed to the defective portion to repair the defective portion, as described herein.

As further shown in FIG. 7, process 700 includes performing a material removal operation to remove excess material of the localized secondary powder bed after the fusing operation (block 760). For example, the 3D printing system may perform a material removal operation to remove excess material of the localized secondary powder bed after the fusing operation, as described herein.

As further shown in FIG. 7, process 700 includes repeating the deposition operation, the fusing operation, and the material removal operation for a plurality of cycles to repair the defective portion (block 770). For example, the 3D printing system may repeat the deposition operation, the fusing operation, and the material removal operation for a plurality of cycles to repair the defective portion, as described herein.

Process 700 may include additional aspects, such as any single aspect or any combination of aspects described below and/or in connection with one or more other processes described elsewhere herein.

In a first aspect, the operations comprise disassembling a portion of the 3D printed object to isolate a repair portion of the 3D printed object.

In a second aspect, alone or in combination with the first aspect, receiving the 3D printed object includes receiving the repair portion of the 3D printed object.

In a third aspect, alone or in combination with one or more of the first and second aspects, receiving the 3D printed object includes receiving the 3D printed object after the 3D printed object has been integrated into an assembly with one or more other objects.

In a fourth aspect, alone or in combination with one or more of the first through third aspects, determining the repair orientation includes determining the repair orientation based on at least one of accessibility of the 3D printing head to the defective portion in the repair orientation, accessibility of depositing the material of the localized secondary powder bed onto the defective portion in the repair orientation, effects of gravity in the repair orientation, or removability of the excess material of the localized secondary powder bed in the repair orientation.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

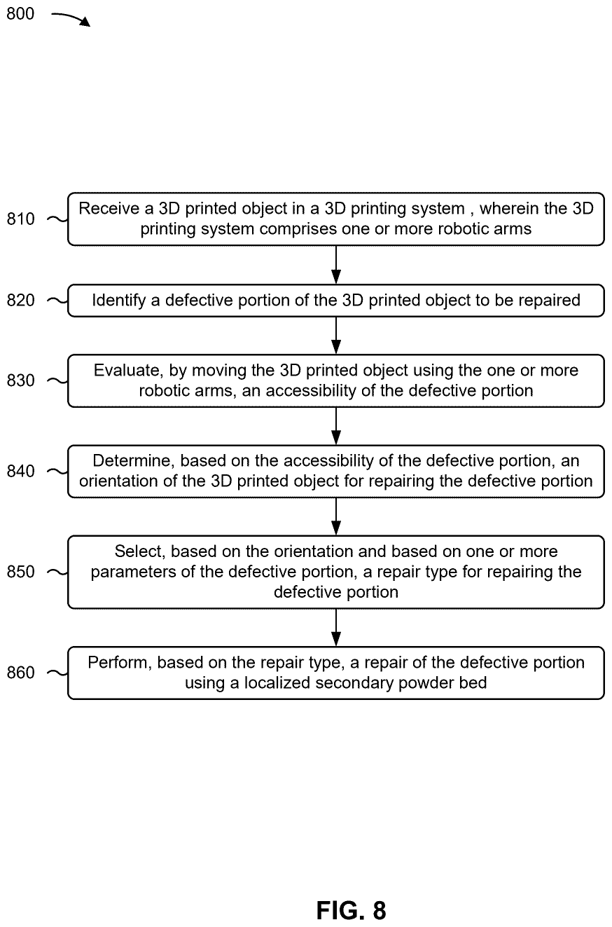

FIG. 8 is a flowchart of an example process 800 associated with repairing a 3D printed object using a secondary powder fusion bed. One or more process blocks of FIG. 8 are performed by a 3D printing system (e.g., 3D printing system 202) and/or by another device or a group of devices separate from or including the 3D printing system, such as a computer (e.g., computer 102). Additionally, or alternatively, one or more process blocks of FIG. 8 may be performed by one or more components of the computer 102, such as the processor set 114, the communication fabric 116, the volatile memory 118, the persistent storage 120, the peripheral device set 122, and/or the network module 124, among other examples. In some implementations, the processor set 114 of the computer 102 may execute the 3D printing repair code 150 to perform one or more of the operations of the example process 800.

As shown in FIG. 8, process 800 includes receiving a 3D printed object in a 3D printing system (block 810). For example, the 3D printing system may receive a 3D printed object in a 3D printing system, as described herein. In some implementations, the 3D printing system includes one or more robotic arms.

As further shown in FIG. 8, process 800 includes identifying a defective portion of the 3D printed object to be repaired (block 820). For example, the 3D printing system may identify a defective portion of the 3D printed object to be repaired, as described herein.

As further shown in FIG. 8, process 800 includes evaluating, by moving the 3D printed object using the one or more robotic arms, an accessibility of the defective portion (block 830). For example, the 3D printing system may evaluate, by moving the 3D printed object using the one or more robotic arms, an accessibility of the defective portion, as described herein.

As further shown in FIG. 8, process 800 includes determining, based on the accessibility of the defective portion, an orientation of the 3D printed object for repairing the defective portion (block 840). For example, the 3d printing system may determine, based on the accessibility of the defective portion, an orientation of the 3D printed object for repairing the defective portion, as described herein.

As further shown in FIG. 8, process 800 includes selecting, based on the orientation and based on one or more parameters of the defective portion, a repair type for repairing the defective portion (block 850). For example, the 3D printing system may select, based on the orientation and based on one or more parameters of the defective portion, a repair type for repairing the defective portion, as described herein.

As further shown in FIG. 8, process 800 includes performing, based on the repair type, a repair of the defective portion using a localized secondary powder bed (block 860). For example, the 3D printing system may perform, based on the repair type, a repair of the defective portion using a localized secondary powder bed, as described herein.

Process 800 may include additional aspects, such as any single aspect or any combination of aspects described below and/or in connection with one or more other processes described elsewhere herein.

In a first aspect, the one or more parameters of the defective portion include at least one of a width of the defective portion, a depth of the defective portion, a shape of the defective portion, or a defect type of the defective portion.

In a second aspect, alone or in combination with the first aspect, selecting the repair type includes selecting a powder bed fusion repair.

In a third aspect, alone or in combination with one or more of the first and second aspects, performing the repair includes performing a deposition operation to deposit material to create the localized secondary powder bed on the defective portion while the one or more robotic arms maintain the 3D printed object in the orientation, performing a fusing operation to fuse the material of the localized secondary powder bed to the defective portion to repair the defective portion, and performing a material removal operation to remove excess material of the localized secondary powder bed after the fusing operation, and repeating the deposition operation, the fusing operation, and the material removal operation for a plurality of cycles to repair the defective portion.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that is at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving a three-dimensional (3D) printed object in a 3D printing system,
wherein the 3D printing system comprises one or more robotic arms;
identifying a defective portion of the 3D printed object to be repaired;
evaluating, by moving the 3D printed object using the one or more robotic arms, an accessibility of the defective portion;
determining, based on the accessibility of the defective portion, an orientation of the 3D printed object for repairing the defective portion;
depositing material to create a localized secondary powder bed on the defective portion while the one or more robotic arms maintain the 3D printed object in the orientation;
fusing the material of the localized secondary powder bed to the defective portion to repair the defective portion; and
removing excess material of the localized secondary powder bed after the defective portion is repaired.

2. The method of claim 1, wherein determining the orientation of the 3D printed object for repairing the defective portion comprises:
determining an orientation of the 3D printed object in which a line of sight between the defective portion and a 3D printing head of a 3D printing system is achieved.

3. The method of claim 1, wherein identifying the defective portion comprises:
scanning the 3D printed object to generate a 3D model representation of the 3D printed object; and
comparing the 3D model representation of the 3D printed object with a 3D model design of the 3D printed object to identify the defective portion.

4. The method of claim 1, further comprising:
selecting the material based on the material being compatible with a powder fusion process for fusing the material to the defective portion.

5. The method of claim 1, further comprising:
selecting the material so that the excess material is removable without damaging the 3D printed object.

6. The method of claim 1, wherein depositing the material to create the localized secondary powder bed comprises:
determining, based on one or more parameters of the defective portion, dimensions and shape for the localized secondary powder bed; and
depositing the material to create the localized secondary powder bed based on the dimensions and shape determined for the localized secondary powder bed.

7. The method of claim 6, wherein determining the dimensions and shape for the localized secondary powder bed comprises:
simulating the repair of the defective portion using machine learning to determine the dimensions and shape for the localized secondary powder bed.

8. The method of claim 1, wherein depositing the material to create the localized secondary powder bed comprises:
depositing the material using a flexible robot material delivery system to create the localized secondary powder bed.

9. The method of claim 1, wherein fusing the material of the localized secondary powder bed to the defective portion to repair the defective portion comprises:
applying a laser beam from a 3D printing head of a 3D printing system to the material of the localized secondary powder bed to fuse the material of the localized secondary powder bed to the defective portion.

10. The method of claim 9, wherein applying the laser beam to the material of the localized secondary powder bed comprises:
applying the laser beam to the material of the localized secondary powder bed in a direct line of sight between the 3D printing head and the defective portion.

11. The method of claim 9, wherein applying the laser beam to the material of the localized secondary powder bed comprises:
applying, using a deflector, the laser beam to the material of the localized secondary powder bed along an indirect path between the 3D printing head and the defective portion.

12. A computer system comprising:
a processor set;
one or more computer-readable storage media; and
program instructions stored on the one or more computer-readable storage media to cause the processor set to perform operations comprising:
receiving a three-dimensional (3D) printed object in a 3D printing system,
wherein the 3D printing system comprises one or more robotic arms;
identifying a defective portion of the 3D printed object to be repaired;
determining, by moving the 3D printed object using the one or more robotic arms, a repair orientation of the 3D printed object for repairing the defective portion,
wherein a direct line of sight between the defective portion and a 3D printing head of a 3D printing system is achieved in the repair orientation;
performing a deposition operation to deposit material to create a localized secondary powder bed on the defective portion while the one or more robotic arms maintain the 3D printed object in the repair orientation;
performing a fusing operation, using the 3D printing head, to fuse the material of the localized secondary powder bed to the defective portion to repair the defective portion;
performing a material removal operation to remove excess material of the localized secondary powder bed after the fusing operation; and
repeating the deposition operation, the fusing operation, and the material removal operation for a plurality of cycles to repair the defective portion.

13. The computer system of claim 12, wherein the operations comprise disassembling a portion of the 3D printed object to isolate a repair portion of the 3D printed object.

14. The computer system of claim 13, wherein receiving the 3D printed object comprises:
receiving the repair portion of the 3D printed object.

15. The computer system of claim 12, wherein receiving the 3D printed object comprises:
receiving the 3D printed object after the 3D printed object has been integrated into an assembly with one or more other objects.

16. The computer system of claim 12, wherein determining the repair orientation comprises:
determining the repair orientation based on at least one of:
accessibility of the 3D printing head to the defective portion in the repair orientation,
accessibility of depositing the material of the localized secondary powder bed onto the defective portion in the repair orientation,
effects of gravity in the repair orientation, or
removability of the excess material of the localized secondary powder bed in the repair orientation.

17. A computer program product comprising:
one or more computer-readable storage media program instructions stored on the one or more computer-readable storage media to perform operations comprising:
receiving a three-dimensional (3D) printed object in a 3D printing system,
wherein the 3D printing system comprises one or more robotic arms;
identifying a defective portion of the 3D printed object to be repaired;
evaluating, by moving the 3D printed object using the one or more robotic arms, an accessibility of the defective portion;
determining, based on the accessibility of the defective portion, an orientation of the 3D printed object for repairing the defective portion;
selecting, based on the orientation and based on one or more parameters of the defective portion, a repair type for repairing the defective portion; and
performing, based on the repair type, a repair of the defective portion using a localized secondary powder bed.

18. The computer program product of claim 17, wherein the one or more parameters of the defective portion comprise at least one of:
a width of the defective portion,
a depth of the defective portion,
a shape of the defective portion, or
a defect type of the defective portion.

19. The computer program product of claim 17, wherein selecting the repair type comprises:
selecting a powder bed fusion repair.

20. The computer program product of claim 19, wherein performing the repair comprises:
performing a deposition operation to deposit material to create the localized secondary powder bed on the defective portion while the one or more robotic arms maintain the 3D printed object in the orientation;
performing a fusing operation to fuse the material of the localized secondary powder bed to the defective portion to repair the defective portion; and
performing a material removal operation to remove excess material of the localized secondary powder bed after the fusing operation; and
repeating the deposition operation, the fusing operation, and the material removal operation for a plurality of cycles to repair the defective portion.
